(19) United States
(12) Patent Application Publication
(10) Pub. No.: US 2006/0282372 A1
(43) Pub. Date: Dec. 14, 2006

(54) Method to secure credit card information stored electronically

(76) Inventors: Timothy Gerard Endres, Houghton, MI (US); Mark H. Schwartz, Livonia, MI (US)

Correspondence Address: Timothy G. Endres, 21801 Peepsock Circle, Houghton, MI, 49931, US

(21) Appl. No.: 11/149,759

(22) Filed: Jun. 9, 2005

(51) Int. Cl. G06Q 40/00; G06Q 99/00; H04L 9/00; H04K 1/00

(52) U.S. Cl. 705/38; 705/76

(57) ABSTRACT

A method by which merchants who store sensitive credit card information can secure the information from theft, while minimizing the impact on the customer, as well as minimizing the cost of implementation. The merchant uses a special secured record for the storage of the credit card information for a specific customer. The record consists of two parts. The first part of the record contains public information which is visible to anyone with access to the record. The public information includes the merchant identity, along with information that constrains the use of the record, such as limits on the type of purchase, amount of purchase, or frequency of purchase, as well as the expiration date of the record, approved shipping addresses, and other constraints that make the record effectively useless to anyone except the merchant who created and stored the record, as well as limiting possible abuse by said merchant. The second part of the record contains private information which is encrypted so as to be visible only to parties authorized to view the information. The private part of the record will contain the sensitive credit card information, along with a checksum of the contents of the record. When the record is submitted to the clearing entity, the private part of the record is decrypted using the appropriate key. The checksum is used to verify that the record has not been modified, and that the public and private sections correspond to each other. Once the record is validated, constraints are applied, and if met, the credit card information is used to process the transaction.

I HEREBY CLAIM PRIORITY OF PROVISIONAL PATENT No. 60/592,586

### FIELD OF THE INVENTION

The present invention relates to systems and methods for facilitating online commerce over public networks (such as the Internet) using credit cards, debits cards, and other types of cards or cash equivalents used for commerce. More specifically, this invention relates to the problem of merchants storing sensitive account information that is subject to theft and misuse. The invention eliminates the problem by encrypting the sensitive information, tying the information to a specific vendor, and constraining the uses of the information.

### BACKGROUND OF THE INVENTION

Online commerce has grown from a novelty into a major fraction of all retail markets, and is growing in both business-to-business and wholesale commerce portions of the economy.

The success of online commerce has been made possible in part by taking certain measures to secure the information involved in the transactions, as well as the identity of the parties involved. For example, the HTTPS protocol is designed to secure the information provided by a customer to a merchant when that information is transmitted over a public network such as the Internet. The HTTPS protocol also provides for the use of Digital Public Key technology to verify that the computer systems that the customer is communicating with are indeed those of the merchant with whom they believe they are transacting business.

Despite many technological advances in securing Internet commerce, several critical weaknesses remain. One of those weaknesses is the databases of sensitive credit card information that are stored by the various merchants with which credit card and other electronic transactions are conducted. A single customer's credit card information may be stored by dozens of online merchants, exposing the customer to multiple points of possible failure. Even if the databases are presumed to be secure both from physical access and from unauthorized network access, a remaining concern is that a credible merchant might unknowingly employ a rogue employee who could steal the credit card information from within the company.

Despite the best efforts of vendors, the theft of credit card information remains a significant problem. Real world cases of credit card database theft are well documented, including successful efforts to extort large sums from the company from which they were stolen. It has been estimated that the cost of this type of fraud, in the United States alone, will reach over 3 billion dollars per year by 2007 ( http://www.epaynews.com/statistics/fraud.html ).

Because the Internet grew very rapidly, with few established protocols addressing specific security issues, it is now a difficult proposition to redesign the typical online transaction to accommodate security needs. Furthermore, companies have invested huge sums of time and capital to develop their existing online systems, and a redesign of those systems would be difficult to coordinate and costly to implement. Thus, any solution must work well with existing, and disparate, merchant systems and networks.

This invention discloses a simple technique for storing sensitive credit card information, along with usage constraints, in a data record that renders the record effectively unusable to anyone who might attempt to steal the record. The method uses existing technologies, requires only minimal modifications to existing merchant and transaction processor systems, and requires no changes to existing networks and network protocols between merchant and customer.

The advantages of this invention over those cited are: 1) the customer does not need a computer; 2) when the transaction is performed online, the customer requires no special software or hardware; 3) the merchant does not need to change the information that is collected from the user, and thus can use existing applications and user interfaces; 4) the method requires only the clearing entity to maintain a single key pair, as opposed to issuing key pairs to each of potentially millions of customers; 5) the method provides constraints that limit the potential uses of a stolen record; 6) the record can be reused for multiple transactions, without requiring the customer to re-enter the stored information, and without reconstructing the record; 7) proxy numbers can be tied to secure records, as opposed to specific transactions, making proxy numbers reusable; 8) existing merchant databases can be secured at minimal cost; 9) key revocation and expiration is managed at the merchant and processor levels, instead of the customer level; 10) cost of key management is greatly reduced compared to “key per customer” approaches.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### SUMMARY OF THE INVENTION

This application claims the benefit of Provisional Patent Application Ser. No. 60592586 filed on Jul. 30, 2004.

This invention concerns a method for securing sensitive information that is stored by a merchant for the purposes of single and/or recurring commerce transactions. The sensitive information usually consists of a sixteen digit credit or debit card number, the card's expiration date, and the card's three or four digit security code, but may consist of any information that should not be visible to anyone except the transaction processor. For example, the sensitive information could consist of a social security number that should be kept secret, to be accessed only by an appropriate governmental agency. Because the information may be transmitted over a public network where it is assumed that eavesdroppers can acquire any information sent over the network, and because the information is stored on a medium that is presumed accessible by employees of the merchant, it is assumed that the record may be read by unauthorized, and potentially malicious, parties. These assumptions are not required for the invention to apply, as the invention is also applicable to private and/or secure networks, as well as secure databases.

To accomplish the objective, a “secured record” is defined. This special record, hereafter also known as “the secured record”, is defined to consist of two critical parts or sections, the public part and the private part. The public part consists of information that is visible and intelligible to anyone who possesses the record. The private part consists of information that is also visible to anyone, but is encrypted using the public key of a key pair and is thus unintelligible to anyone except the owner of the private key that corresponds to the public key used to encrypt the information. The key pairs can be assigned on a per-merchant basis in order to minimize revocation and expiration costs. Finally, to ensure the integrity of the record, a checksum of the entire record is included in the private part of the record, allowing for the verification of the record's contents at processing time.

The customer does not require any special software or hardware for executing their online transactions with the method. In fact, the method will work for those customers who make their purchases over the phone, or by post, or by any other means. From the customer's point of view, there is no change in the purchase process except that they are ensured their sensitive information is protected from theft.

The merchant is required to modify the task flow of their automated processing systems. In the case of storing a customer's sensitive credit card information, the merchant will use a function implemented in a software library to create the secured record, and they will need to store the secured record in place of the sensitive information. Since the sensitive information typically includes a sixteen digit card number, the merchant can compute an internal lookup key that is placed into the existing card number field, and then use this lookup key to retrieve the secured record from a separate storage location, minimizing the changes required to support the new secured record. The merchant then uses a secured charge record, which is based upon the new secured record, to submit future charge requests.

The transaction processor is required to modify the task flow of their automated processing systems to accommodate the secured charge record, which is based upon the new secured record. In the event that existing protocols allow for the direct transmission of the secured charge record, then the record shall be transmitted directly to the processor. The processor will then use their private key to decrypt the private part of the secured record once it is extracted from the secured charge record. The processor will then use the checksum retrieved from the decrypted private section to verify the integrity of the secured record. Once the record is verified, the processor will apply filters based on the constraints that are defined by the secured record, such as confirming the merchant submitting the transaction, and the amount and frequency of the transaction. Once the record has passed verification and constraint filters, the processor will retrieve from the private section the credit card information needed to continue processing of the transaction using the existing prior art procedures.

In the cases where a transaction processor does not have the capability to receive the secured charge request, due to rigid protocols that are difficult to change for example, or in the case where a merchant is incapable of meeting the secured record processing and transmission requirements, a proxy number may be used to stand in for the secured record. In this case, the transaction processor will issue a number that looks exactly like a number normally issued by the processor (for example, sixteen digit credit card numbers), which by definition will work with existing protocols and systems. The number will be a proxy for the secured record which is stored with the transaction processor, and will be acceptable for payment as if it were a standard credit or debit card number. The proxy number, when received by a transaction processor, will then be used to retrieve the corresponding secured record, which is then processed to complete the transaction.

Because the proxy number is issued to represent a secured record, as opposed to being issued on a per transaction basis, the proxy number can be reused. It can also be stored using existing systems designed for credit card numbers, as it is indistinguishable from a normal processor number such as a credit card number. Furthermore, customers can be issued physical cards containing the proxy number, just as they are issued standard credit cards today, allowing their use at physical credit card points of sale just as if they were standard credit cards. Thus, merchants with both a physical storefront, as well as an online presence, could issue a proxy number electronically via email, as well as issue a physical credit card with the proxy number. The physical card could even be printed directly from a web page.

Once a secured charge record is received from a merchant and the secured record extracted from it, or a standard charge record using a proxy number is used to retrieve a secured record from a database, the transaction processor will decrypt the private section of the secured record, validate the record integrity using the checksum from the private section, and validate the transaction constraints. If all of the validations pass, then the credit card information contained in the secured record is accepted and used to complete the transaction using existing processing methods. Otherwise the charge is rejected.

In order to facilitate the creation of the secured record, the transaction processor can provide the required public key via the Internet using a number of well established methods. The public key could even be delivered via post on a floppy disk or CD. Typically, for the sake of minimizing key-revocation and expiration costs, public/private key pairs will be assigned on a per-merchant basis, although this is not a requirement. The processor can also provide software libraries and/or program source code to facilitate the retrieval of their public key, the creation of the secured records, and the transmission of the secured charge records. This computer software allows the merchants to integrate the secured record creation and transmission procedures anywhere within their existing processing pipeline. To further simplify the creation of secured records, the processor could provide a web service, or any other digital service, for secured record creation and distribution. Using such a system, the merchant could deliver to the processor all necessary information via a secure connection, such as HTTPS, and receive back a secured record for storage and future use.

Alternatively, the transaction processor could provide software which would allow the customer to generate the secured record locally on the customer's computer before it is transmitted to a merchant or the processor. Thus it is protected from compromise before the secured record information leaves the customer's computer.

Finally, the huge numbers of credit card records currently existing in merchant databases can be protected by a batch process that will create the secured records for all existing customer records, and then delete the stored sensitive credit card information. Furthermore, this process of conversion can be done in a piecewise fashion, across both merchants and processors, allowing for a staged, orderly transition from current practices to the invention method.

Thus, the only modifications to the existing transaction model are: 1) the merchant must add the ability to generate or retrieve the secured record, store the secured record if needed, and submit charges using the secured charge record; 2) the protocol between the merchant and transaction processor must accommodate transmission of the secured charge record in each transaction; and 3) the transaction processor must add the ability to validate the secured record and to extract the sensitive credit card information for further processing.

In the case of using a proxy number, the transaction processor must be capable of generating secured records, storing secured records, associating the secured record to a proxy number, issuing the proxy number to clients, recognizing the proxy number in transactions, retrieving the secured record that the proxy number represents, and validating and extracting the credit card information from the secured record.

By securing the sensitive credit card information with encryption, tying the use of the credit card to a specific vendor or vendors, and adding usage constraints, the risk of fraud and abuse from the theft of stored credit card information is virtually eliminated. The value of a customer record that can only permit purchase of a limited amount of goods or services from a single vendor or list of vendors, and which can only ship to a specific address, and can only be used for a finite time, makes the stored record virtually useless to anyone except the owner of the credit card and the merchant with whom it is used. The use of secured record proxy numbers makes the method backwards compatible with existing processing networks. In the event that a secured record is desired to be usable by multiple merchants, the invention provides for this, however the secured record creation process would be different in that the secured record generation and distribution must be coordinated amongst the merchants and possibly the transaction processor. In the event that it may be desirable to be able to submit the same secured record to multiple clearing entities, the patent allows for additional private sections, one for each clearing entity. In such a secured record, each private section is encrypted with a different public key corresponding to the different clearing entities. In each private section, the stored checksum is computed over the header (if used), the public section, and only the private section being defined. Thus, each private section has its own checksum of the public section and itself, allowing each clearing entity to verify and process the record without any regard for the other private sections.

### BRIEF DESCRIPTION OF THE DRAWINGS

The present invention will become more fully understood from the detailed description and the accompanying drawings, wherein:

FIG. 1 shows a general overview of the method to secure credit card transactions and information in accordance with the present invention.

FIG. 2 shows a general representation of the structure of the secured record defined by the present invention.

FIG. 3-A shows a sample summary of the fields of the public section of the secured record.

FIG. 3-B shows an embodiment in XML of an example of the public section of the secured record.

FIG. 4-A shows a sample summary of the fields of the private section of the secured record.

FIG. 4-B shows an embodiment in XML of an example for the private section of the secured record.

FIG. 5 shows the process flow diagram for the customer registration process as employed in electronic Internet commerce as conducted by customers and merchants in prior art.

FIG. 6 shows the process flow diagram for the purchase process as employed in electronic Internet commerce as conducted by customers, merchants, and transaction processors in prior art.

FIG. 7 shows the process flow diagram for the customer registration process as employed in electronic Internet commerce as conducted by merchants and customers in accordance with the present invention.

FIG. 8 shows the process flow diagram for the purchase process as employed in electronic Internet commerce as conducted by customers, merchants, and transaction processors in accordance with the present invention.

FIG. 9 shows an overview of the process flow diagram for the payment process as employed in electronic Internet commerce as conducted by merchants and transaction processors in accordance with the present invention.

FIG. 10-A shows a flow diagram to process open charge records in implementation of the payment process in accordance with the present invention.

FIG. 10-B shows a flow diagram to process secured charge records in implementation of the payment process in accordance with the present invention.

FIG. 10-C shows a process flow diagram to process secured charge records using a single use secured record in implementation of the payment process in accordance with the present invention.

FIG. 11 shows the process flow diagram for the method to generate secured records in accordance with the present invention.

FIG. 12 shows the process flow diagram for the method to decrypt and validate secured records in accordance with the present invention.

FIG. 13 shows the detail of the process flow diagram for the method to extract credit card information from the secured records in accordance with the present invention.

FIG. 14 shows the process flow diagram for the method to use a proxy number for an online transaction in accordance with the present invention.

FIG. 15 shows the general structure of the key revocation process updating all secured records with a new public key in accordance with the present invention.

### REFERENCE NUMERALS

20 Public Key
22 Private Key
24 Old Private Key
26 New Public Key
30 Customer
32 Merchant
34 Transaction Processor
40 Customer Information Database-Secured
42 Customer Information Database-Unsecured
44 Proxy Information Database
46 Update Request Database
50 Registration-Web Page
55 Shopping Cart-Web Page
90 Unsecured Record
91 Merchant Standard Charge Record
92 Merchant Secured Charge Record
93 Credit Card Details
94 Charge Information
95 Credit Card Info & Charge Details
96 Secured Record Information
97 Purchase Information
98 Customer Information
99 Open Charge Record
100 Secured Record
100-A Secured Record Unencrypted
100-B Secured Record Unencrypted w/computed Checksum
100-C Secured Record Encrypted w/computed Checksum
110 Header-Secured Record
120 Public Section-Secured Record
130 Private Section-Secured Record
140 Checksum-Secured Record
120 Public Section
121 Customer Name
122 Customer Ship Address
123 Customer ID
124 Merchant ID
125 Constraint Definitions
130 Private Section
131 Credit Card Number
132 Credit Card Expiration
133 Credit Card Security Number
134 Constraints & Other
140 Record Checksum
200 Secured Credit Card Transactions using Secured Records
210 Registration Process Overview
220 Purchase Process Overview
230 Payment Process Overview
250 Traditional Credit Card Processing
300 Registration Process-Prior Art
350 Purchase Process-Prior Art
400 Registration Process-Invention
410 Generate Secured Record
500 Purchase Process-Invention
550 Create Secured Charge Record
600 Payment Process-Invention
610 Process Secured Charge Record
610-A Simple Secure Method-Process Open Charge Record
610-B Secure Method-Process Secured Charge Record
610-C Single Use Secure Method-Process Single Use Secured Record
620 Decrypt & Validate Secured Record
630 Decrypt Secured Charge Record
640 Extract Secured Record & Charge Details
650 Extract Open Charge Record
660 Extract Credit Card Information
700 Use of Proxy Number
800 Key Revocation Process

### DETAILED DESCRIPTION OF THE PREFERRED EMBODIMENTS

The following description of the preferred embodiment(s) is merely exemplary in nature and is in no way intended to limit the invention, its application, or uses.

The following discussion assumes the reader is familiar with digital information cryptography; specifically public key cryptography using key pairs where one key is public and the other key is private. Further, familiarity with PKCS standards (available at the online library at www.rsa.com), the ASN.1 standard, and their uses, is helpful in understanding the details of the embodiment.

The invention includes elements for (1) security—as provided by the encryption of the private section containing the sensitive information; (2) integrity—as provided by the calculation of a checksum of the record contents to verify that the contents have not been modified and to inextricably link the public and the private sections of the record; (3) constraint—as provided by tying the record to a merchant or merchants, as well as various usage constraints as defined in the public and private sections of the record. The invention combines these elements to provide both a secured transaction method and a secured record structure which meet the objectives to permit no modification or loss of data, to allow access to the sensitive information only on a need to know basis, to protect transmittal of the purchase transaction information between a merchant and their transaction processor, and to render the sensitive information safe for storage in a merchant or transaction processor database.

### Structural Overview of the Secured Record of the Preferred Embodiment

The essential elements of the general secured record 100 definition include the following: 1) a flexible record definition which allows for multiple data representations (e.g. UNICODE text, and binary data), as well as the ability to modify the elements of the record definition without invalidating existing records (also known as backwards compatible extensions); 2) said public section 120 which may be read by anyone who has access to the secured record 100; 3) said private section 130 which can only be read by the party who possesses the private key 22 which corresponds to the public key 20 used to encrypt the data in the private section 130; 4) said checksum 140 in the private section 130 which can be used to validate the integrity of the record.

If any one of these four elements is missing, then the secured record 100 loses its ability to provide the required security, integrity, and constraint created by the invention. The flexible definition for the secured record 100 provides for the other essential elements. The public section 120 is necessary to make the record usable and manageable by parties other than the transaction processor 230. The encrypted private section 130 is necessary to keep the sensitive information private, as well as prevent tampering with the checksum 140. The checksum 140 is necessary to prevent tampering with the record's contents. In theory, the checksum need only be applied to the header and public sections of the record, however, this would be considered a weaker implementation from a cryptographic point of view. While the record header is not absolutely required, the benefits of the header make its omission very unlikely.

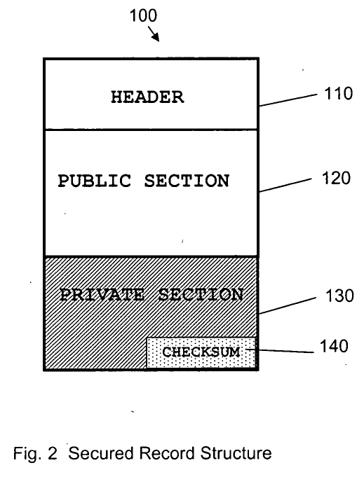

Shown in FIG. 2 is a general representation of the secured record structure 100 defined by the invention. As described above, in general, the secured record 100 consists of three main parts; a header section 110, a public section 120, and a private section 130. A checksum 140 is embedded in said private section 130. The order of the sections is not important, although the header is typically first for obvious reasons. The specific implementation of the secured record 100 is not pertinent to the invention description. It is possible that the definition established by a major transaction processor would become the de-facto standard.

When considering an actual implementation of the secured record 100, however, some existing standards would provide adequate building blocks with which to define a standard for the secured record 100. The ASN.1 standard provides a means to define general records that are transportable to other platforms and operating systems, and has existing implementations, thus making it a good choice for manifesting the record as digital data. The PKCS standards provide a well established structure for the definition of records involving encryption, checksums, keys, and identities, making it a good choice for defining the secured record's contents. Thus, the inventors expect that a combination of PKCS and ASN.1 might be used to implement the secured record 100 in practice, however, this is not a requirement of the invention, and other choices are viable.

### Header Section of the Secured Record

The secured record 100 is typically prefixed by a header section 110 which provides information such as the size of the record, the version of the record's definition, and other possible general fields which might describe meta-information about the secured record 100. The version field can be used to provide for backwards compatibility, as well as performing compatibility checks. Possible meta-information might include, for example, MIME data types used to describe the type of data that a field in the record represents, as well as the possible means of viewing the field's contents. The header is not absolutely required for the present invention, however the benefit of its functionality makes its omission very unlikely.

### Public Section of the Secured Record

The public section of the secured record contains information that must be visible to make the record usable by all parties. Examples of this information might be the customer's name, the approved shipping addresses, the merchant id, and so on. The fields placed in the public section 120 are primarily for the purposes of handling the secured record. For example, the merchant storing the record may wish to be able to see the customer's shipping address to automatically fill the fields of an online form used during an online checkout procedure. Another example might be a field showing the last four digits of the credit card number to allow the customer to identify the credit card represented by the secured record. Yet another might be a constraint, such as a per transaction charge limit, that the vendor could reference at checkout time, for example, to attempt to identify fraudulent uses of the record or to provide various services to their customers.

Furthermore, the public section of the secured record can identify fields that have been moved to the private section due to their perceived sensitivity, or because they are not required to be public by the customer or the merchant. An example of this type of moved field might be the per transaction purchase limit. Since this limit can be applied by the transaction processor's constraint filtering, it is not required to be checked by the merchant, and may be considered sensitive information by the customer.

The required fields in the public section 120 are: 1) a globally unique merchant id or merchant id's to be used by the transaction processor; 2) a merchant's customer id for a merchant to identify the customer to which the record belongs; 3) a merchant record id for a merchant to uniquely identify the record.

The public section often contains constraint definitions used to restrict use of the secured record. Additionally for convenience, transaction processor versions of the customer id and record id may be included in the public header, to facilitate sharing of the same record by both merchant and processor, although the credit card information typically identifies the customer for the transaction processor. Other fields in the public section 120 may include a description of the key and method used to encrypt the private section of the record.

In the case that a standard record structure such as PKCS7 is used, the PKCS7 standard will provide the description of the encryption method and key pair. In this case, the requirement for the key and encryption method used for the private section to be included in the public section is unnecessary.

The record and customer id fields may have both transaction processor and merchant versions. This allows the merchant and transaction processor to share record definitions while using their own internal ids. The globally unique merchant id or ids is what ties the record to that merchant or merchants for all future purchases. The encryption description allows for the support of different encryption standards, which is often required to accommodate international laws, patents infringements, and other issues.

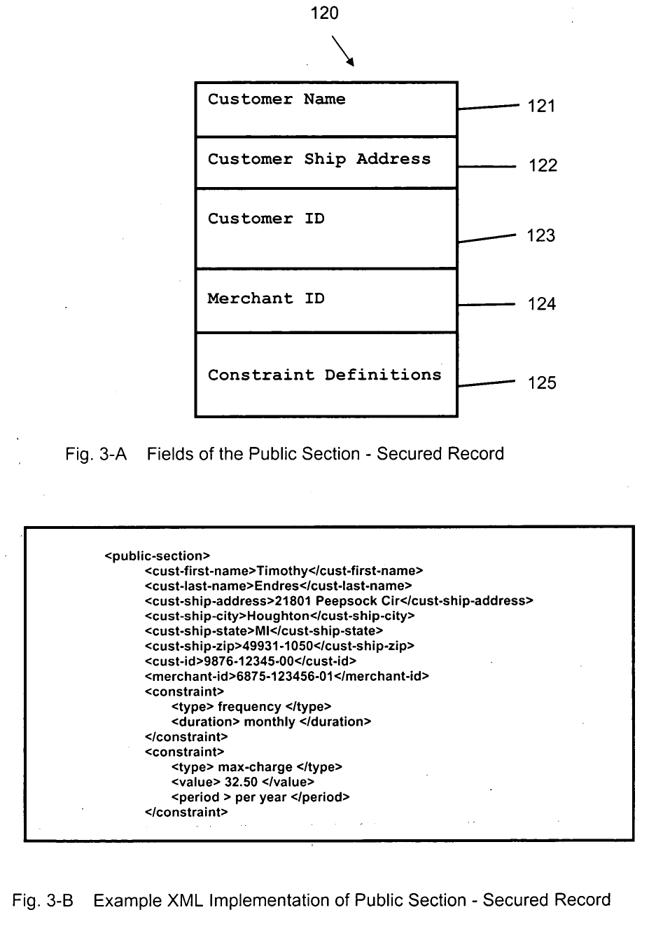

Shown in FIG. 3-A, is one possible embodiment of the public section 120 of the secured record 100. This version contains fields for the customer name 121, customer shipping address 122, customer id 123, merchant id 124, and constraint definitions 125.

Extensible Markup Language (XML) is a simple, flexible text format which plays a significant role in the exchange of a wide variety of data on the Internet. Shown in FIG. 3-B is an example of a possible definition for the public section of the secured record as implemented using XML in accordance with the present invention. In the example, the public section is a simple list of fields. The fields consist of name/value data-pairs. As can be seen in FIG. 3-B, the customer name field 121 will preferably contain name/value pairs for both first and last names. The customer shipping address 122 will preferably contain name/value pairs for street, city, state, zip code, and country information. Constraint definitions field 125 can, for example, be used to set restrictions on the permissible frequency of charge events, the total duration interval in which these charge events may occur, a group of purchase types to limit the kind of goods which can be bought, and even price limits for particular purchase types. Knowing that these constraints are in force will serve to make a customer more confident in the use of their credit card over the Internet with merchants who can offer this advanced level of assurance with regard to the handling of the customer's sensitive credit card information.

### Private Section of the Secured Record

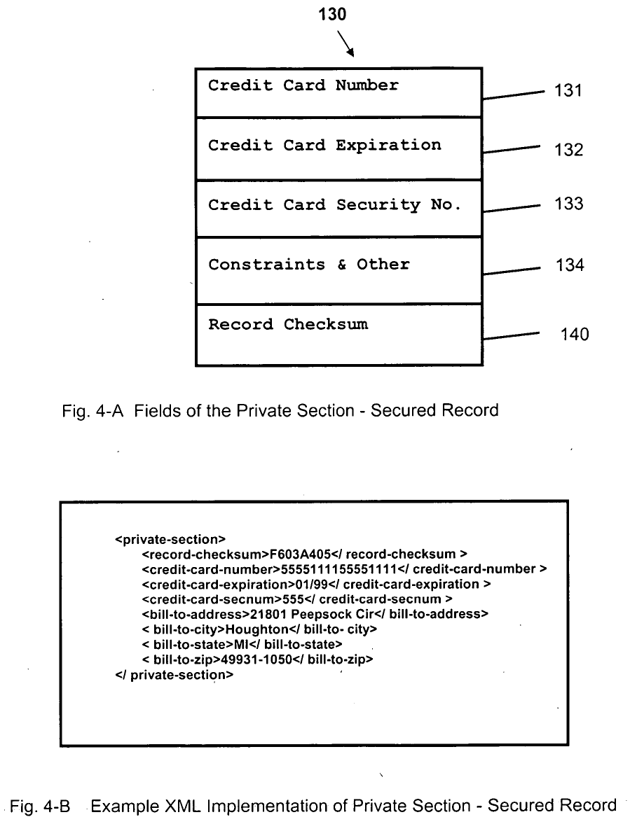

Shown in FIG. 4-A, is an example of the private section 130 of the secured record 100. This version contains fields for the credit card number 131, credit card expiration date 132, and credit card security number 133 which is typically located on the back of the card. It may also contain constraint definitions and other fields 134 which can be used only by the transaction processor. The other fields can provide additional information to further verify the identity of the customer or for any other general purpose to support verification or processing. If the transaction processor creates the secured record, it becomes possible to provide for fields and constraints which are never visible to the merchant. FIG. 4-B shows an example of a possible definition for the private section 130 of the secured record 100 as implemented using XML in accordance with the present invention. As can be seen in FIG. 4-B, the private section 130 may preferably contain in addition to the fields already mentioned the billing address for the customer. When distinct from the ship-to address, restricting viewing of the bill-to address information to only the transaction processor removes another piece of personal information from viewing by parties that do not require access to the information.

The required fields in the private section 130 include: 1) the credit card information necessary to complete processing (e.g., the card number, expiration date, and security number); 2) the checksum 140 of the public section data.

The private section 130 data, once it is completely assembled, is encrypted using the public key 20 of the transaction processor 34. Or, a one-shot encryption key may be generated and used to encrypt the private data, after which the one-shot key is included in the public section after being encrypted using the public key 20 of the transaction processor 34. In either case, the private section can only be viewed by the possessor of the private key corresponding to said public key.

The public key 20 can be given to anyone, and can be easily transmitted over the Internet using, for example, web services or email. PKCS standards define data structures and methods that can be used to store, transmit, and email public keys, and it is expected that these existing mechanisms would be used for this purpose. However, this is not a requirement of the invention, and because the key is public, any effective means of transmitting the public key 20 to the merchants is acceptable.

In order to decrypt the private section 130 data, the private key 22 corresponding to the public key 20 must be used to decrypt the data, or, in the case of the one-shot key being used, the private key 22 must be used to decrypt the one-shot key, which is then used to decrypt the private section 130 data. Therefore, the private section 130 data can only be decrypted, and thus can only be viewed, by the transaction processor 34 owning the private key 34. As such, the private keys become the primary, and singular, point of failure. Only the theft of the private key, or the reverse engineering (cracking) of the private key, can allow unauthorized access to the sensitive information.

### Generation of the Secured Record

In order to create the secured record 100, the creator needs the following information: 1) The public key 20 provided by the transaction processor 230; 2) the public information for the public section 120, such as customer identification, merchant id, public constraints, etc.; 3) the private information for the private section 130, such as the sensitive credit card information.

The following general steps are followed to generate the secured record 100: 1) assemble the public section 120 data into its proper standard format by combining the field name/value pairs required, and construct the public section 120 data structure; 2) assemble the private section 130 data into its proper standard format by combining the field name/value pairs required, and construct the private section 130 data structure; 3) combine the public section 120 and private section 130, along with the record header 110 information, into the secured record 100 data structure; 4) compute checksum 140 and store in private section 130; 5) encrypt the private section 130.

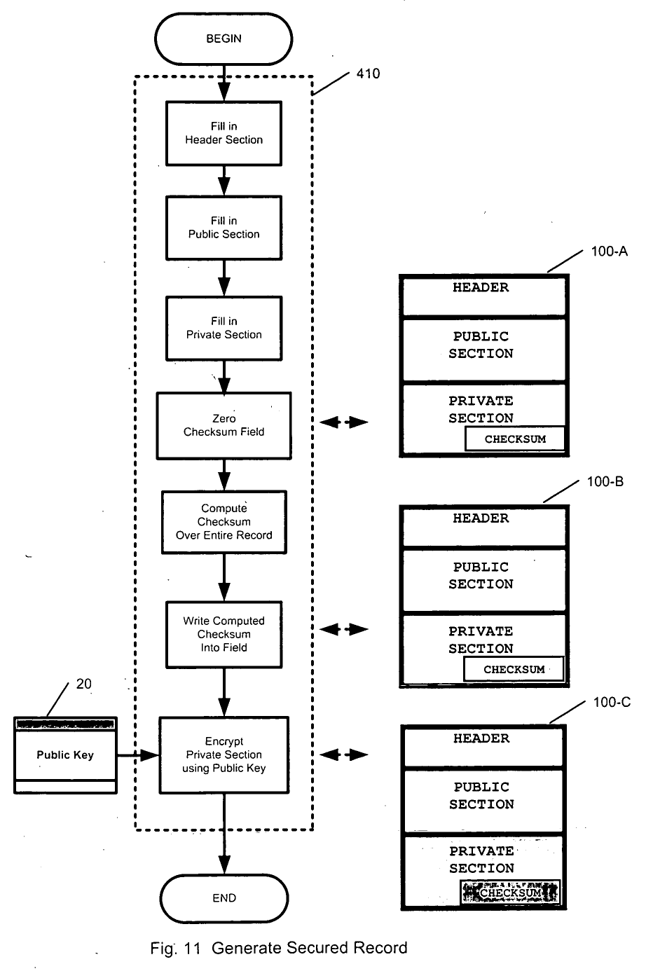

To create the secured record 100, a function call to a software library will likely be used. FIG. 11 shows an overview of the steps the library software will perform in order to generate the secured record 410. As shown, the software must fill in the header section, fill in the public section 120, fill in the private section 130, zero the checksum field 140. Completion of these steps results in the unencrypted secured record 100-A. It is then possible to employ any number of checksum computation algorithms to compute the checksum 140 of the entire record. This computed value is then inserted back into the field resulting in the unencrypted secured record with computed checksum 100-B. The public key 20 provided by the transaction processor 34 is used to encrypt the private section 130 including the checksum field 140 thereby resulting in the encrypted secured record 100-C.

While the invention uses a checksum of the entire record, a checksum may be performed over only the header and public section as an absolute minimum. This technique is weaker, from a cryptographic point of view, but still achieves the objective of assuring record integrity. Other checksum strategies exist, but offer no significant advantages over a checksum of the entire record, in terms of validating record integrity.

### Extraction of the Secured Record

In order to extract information from a secured record 100, the transaction processor 34 needs the following information: 1) The private key 22 corresponding to the public key 20 which was provided by the transaction processor 34 previously for the secured record generation 410 process; 2) the encrypted secured record 100-C.

The following general steps are followed by the processor 34 to extract the encrypted secured record 100-C received from a merchant 32: 1) decrypt the private section 130 of the secured record 100; 2) validate the secured record 100 information using the checksum from the private section; 3) validate the transaction constraints 125; 4) if all of the constraints for validation are met, then the credit card information 93 contained in the record is used to complete the transaction using traditional processing.

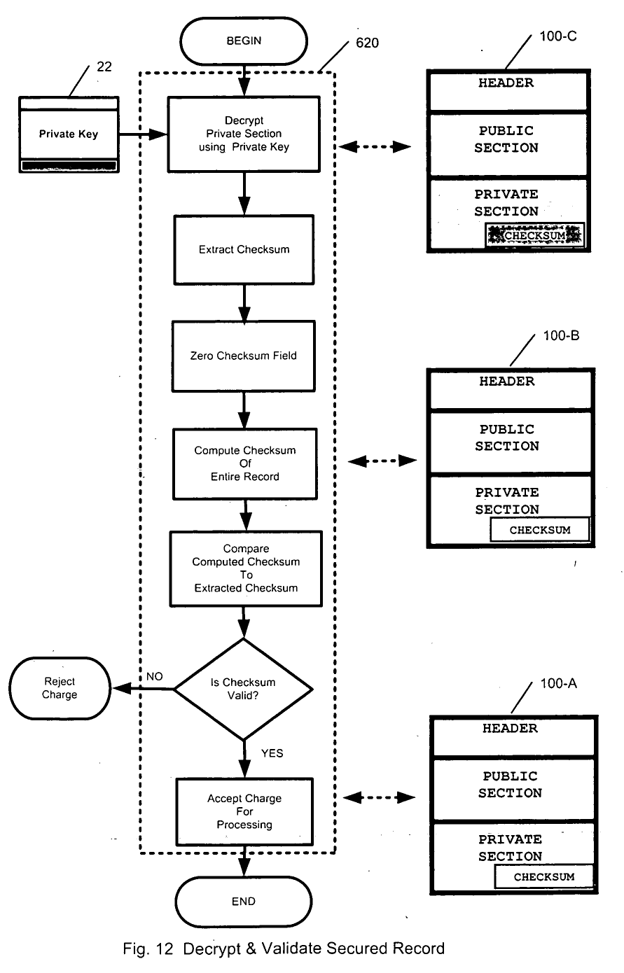

To decrypt and validate the secured record 620, a function call to a software library may be used. FIG. 12 shows an overview of the steps the library software will perform in order to accept a secured record 100 for payment processing. As shown, the process to decrypt and validate the secured record 620 employs the private key 22 to decrypt the private section 130, extracts the checksum field 140, zeroes the checksum field, computes the checksum of the entire secured record, and then compares the newly computed checksum with the checksum value previously extracted. If the two checksum values are not identical, that is if the “is checksum valid test?” test fails, it means that the secured record 100 was tampered with, and the associated charge request is rejected. Otherwise, if the checksum fields are identical, it means that the encrypted secured record 100-C was not violated. This positive finding allows the associated charge request to be accepted for processing. Completion of these steps results in the unencrypted secured record 100-A.

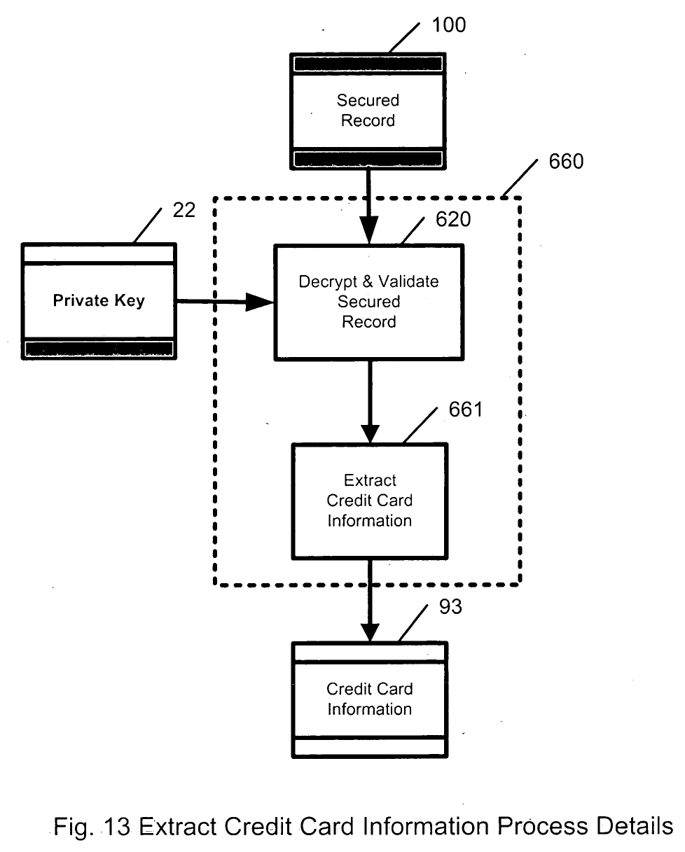

Shown in FIG. 13 is an overview of credit card information extraction process 660. It consists of two main sub-processes. They are the decrypt & validate secured record 620 process followed by the extract credit card information process 661 which copies or isolates the credit card information 93 from the decrypted secured record 100-A.

### Method for Credit Card Processing Using Prior Art

The general structure of electronic commerce implemented by merchants and transaction processors at the present time has a major vulnerability in the storage and transmission of unsecured customer credit information. As practiced using prior art, the customer registration and customer purchase processes together consist of several general steps: 1) the merchant collects information from the customer including the credit card number, expiration date, security code, etc., and stores this information in a database or file; 2) during a purchase, the merchant retrieves the customer's credit card information from storage; 3) the merchant submits the charge transaction to the transaction processor over a network.

The salient points in this process are the storage of the customer's credit card information for use in purchases, and the transmission of the unsecured credit card charge details to the transaction processor. Both of these are potential points of attack.

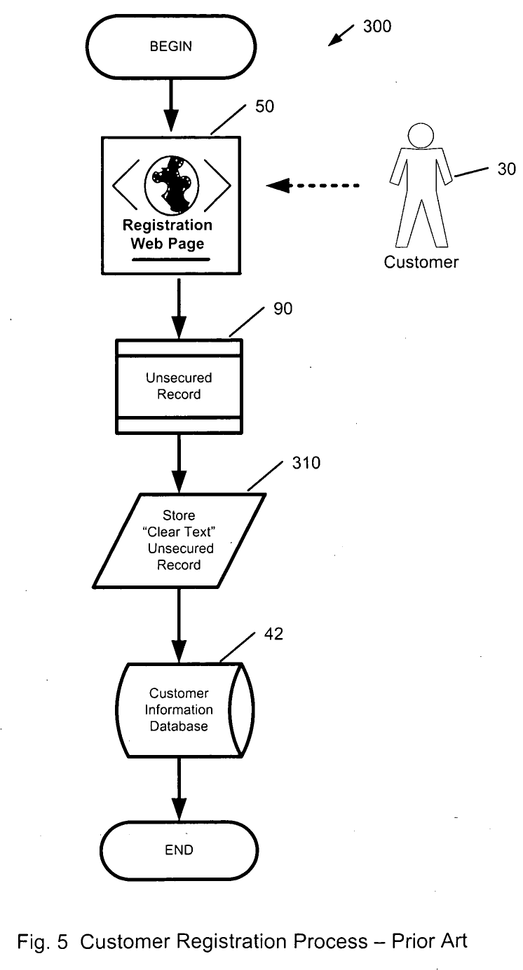

FIG. 5 specifically shows the customer registration process 300 as practice by prior art. The customer 30 completes a registration web page 50. This acquired information, including sensitive information, is packaged in an unsecured record 90. Alternatively, the merchant 32 can, after communication in some other fashion with the customer 30 to acquire the relevant information, create the unsecured record 90.

A store unsecured record process 310 performs the simple operation of storage of the sensitive customer information contained in the unsecured record 90 into a customer information database 42. Because these prior art databases may store the sensitive credit card information in an unencrypted fashion they have been targeted and their customer credit card information successfully stolen not only by remote hackers over the Internet but also by rogue merchant employees or clients with direct physical or electronic access to the customer information database 42.

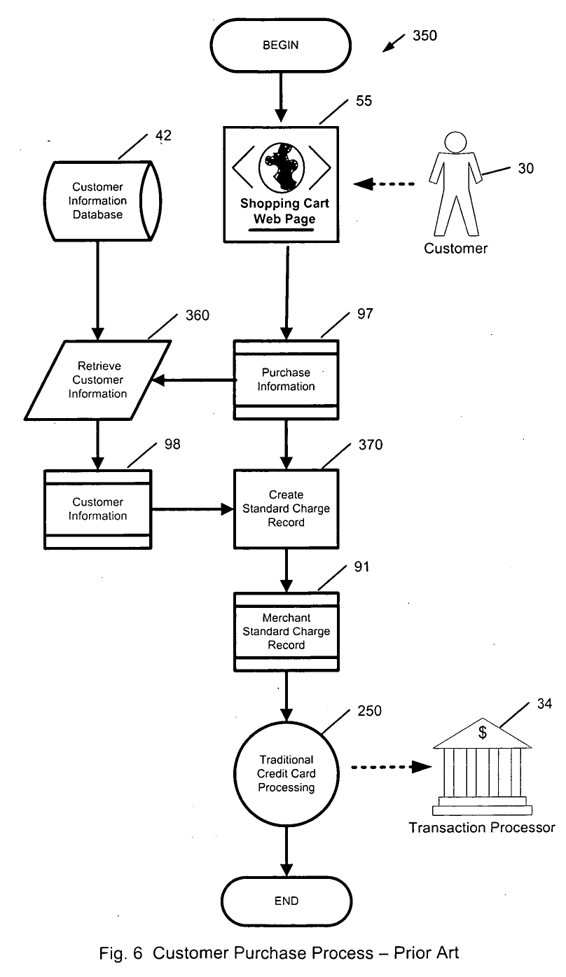

FIG. 6 specifically shows the customer purchase process 350 as practiced using prior art. The customer 30 makes a purchase from an online merchant by completing a shopping cart web page 55. Alternatively, this information can be acquired from the customer 30 by some other means such as by telephone. This purchase information is then used in a process to retrieve the pertinent customer information 360 pertaining to the customer 30. The create standard charge record process 370 combines the customer information 98 successfully retrieved from the database and the purchase information 97 to result in the merchant standard charge record 91. The standard charge record 91 contains all the information necessary to be submitted to the transaction processor 34 for traditional credit card processing 250.

### Security of Electronic Commerce Using the Invention

The essential differences between the new structure of electronic commerce using the invention and the traditional processes exist at the handling by merchants of the registration and purchase procedures, and at the handling by transaction processors of incoming charge requests and the handling of proxy numbers.

In the non-proxy case, the merchant must extend their storage to accommodate the new secured record. The simplest way to accomplish this is for the merchant to generate a unique lookup key that is stored in the location previously used to store the customer's credit card number. This lookup key is then used as an index into the secured record database to retrieve the secured record belonging to the customer. The merchant must also modify existing software, or add some other processing in order to generate the secured record from the information provided by the customer at registration time, and store it into the database. Alternatively, the merchant could make a request to the processor to have the record generated for them. Additionally, the merchant must modify their charge processing to accommodate the transmission of the new secured charge request . In the proxy number case, the merchant does not need to make any changes to its systems or procedures.

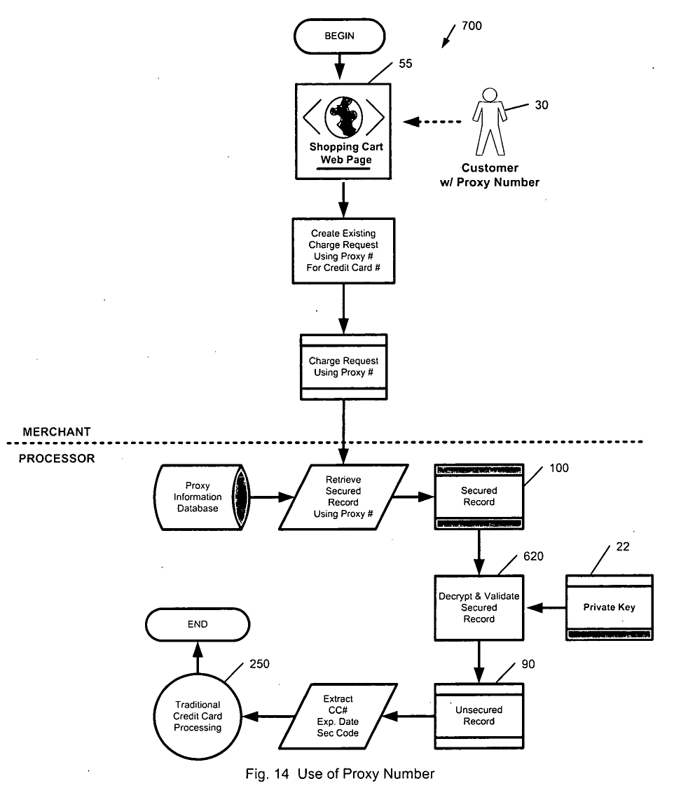

In the non-proxy case, the transaction processor must modify their systems to accommodate receiving secured charge requests utilizing the new secured charge request. The transaction processor must also modify existing software, or otherwise add new processing, in order to process the transaction using the new secured record. This includes, decrypting the secured record, verifying the secured record, and applying constraint filters. If all processing is successful, then the customer's credit card information is retrieved from the private section of the secured record, and it used to continue the charge transaction just as all normal or prior art credit card transactions are processed. In the proxy case, the transaction processor must recognize the proxy number and map it to a secured record in the database. The proxy case is shown in FIG. 14 and discussed below.

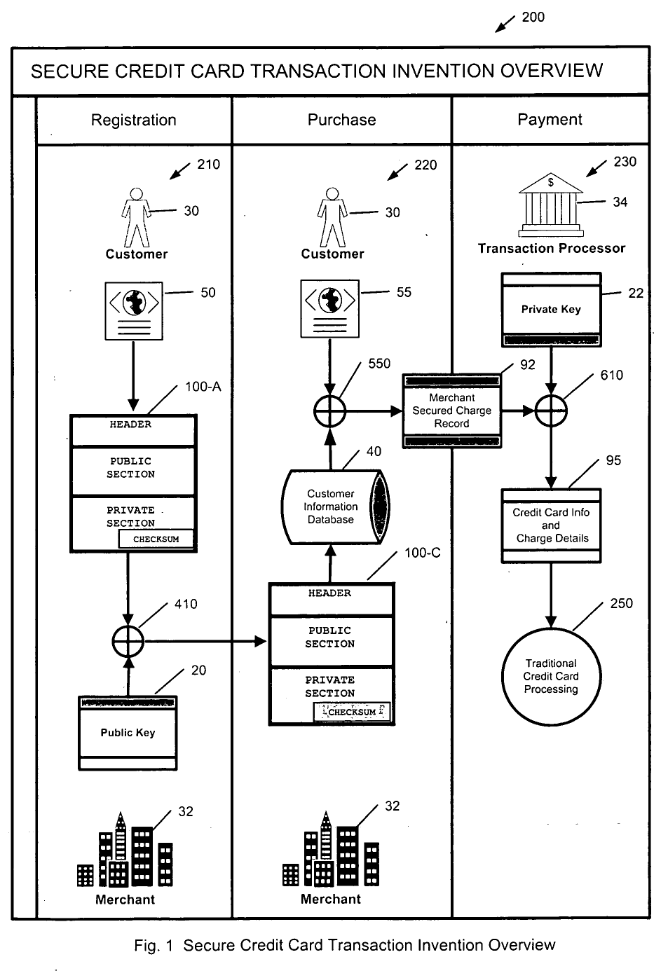

A high level overview of a preferred embodiment of the present invention is depicted in FIG. 1 which illustrates the new secure credit card transaction 200 process. FIG. 1 shows the key changes to the customer registration process 210, purchase process 220, and payment process 230. The figure indicates the parties necessary for each phase of credit card transaction 200. As shown, a customer 30 and a merchant 32 participate in the registration process 210 and purchase process 220. Said merchant 32 communicates with a transaction processor 34 that performs the payment process 230.

As shown in FIG. 1, for the registration process 210, the merchant 32 provides a registration web page 50. Customer 30 provides the solicited information which is sufficient to complete the unencrypted secured record 100-A. A generate secured record process 410 then uses the public key 20 provided to the merchant 32 by the transaction processor 34 to generate the encrypted secured record 100-C.

Also shown in FIG. 1, is the purchase process 220, for which the merchant 32 provides a shopping cart web page 55. Customer 30 provides the solicited information for their desired products. A create secured charge record process 550 retrieves the secured record 100-C and produces the merchant secured charge record 92 for transmittal to the transaction processor 34.

The last phase of the new invention for secure credit card commerce 200 is shown in FIG. 1 as the payment process 230. The merchant 32 transmits the secured charge record 92 to transaction processor 34. Said transaction processor 34 then uses their private key 22, corresponding to the public key 20 previously used to create the secured records, for a decrypt secured charge record process 610 on said secured charge record 92. The output of the decryption process is the credit card information and charge detail information 95 which can then undergo traditional credit card processing 250.

The present invention leverages the storage of the credit card number by the merchant to facilitate the storage and retrieval of the secured record. Because, by definition, the credit card number is no longer used, as it is now secreted away in the secured record, this now unused field can be leveraged by the merchant to store the lookup key for the new database that will contain the new secured record. This not only eases the effort required to support the new secured record, but also greatly simplifies the task of securing existing customer records with no change to existing data structures or databases. This feature is essential to improve adoption of the invention.

A further enhancement can be made by using the last four digits of the new secured record key to store the last four digits of the real credit card number. The remaining digits are used for the actual secured record key. This provides backward compatibility with existing systems which display the last four digits of the credit card number as a visual cue for the customer and or merchant. These features will help advance adoption of the invention.

### Method for Secure Credit Card Processing Using the Invention

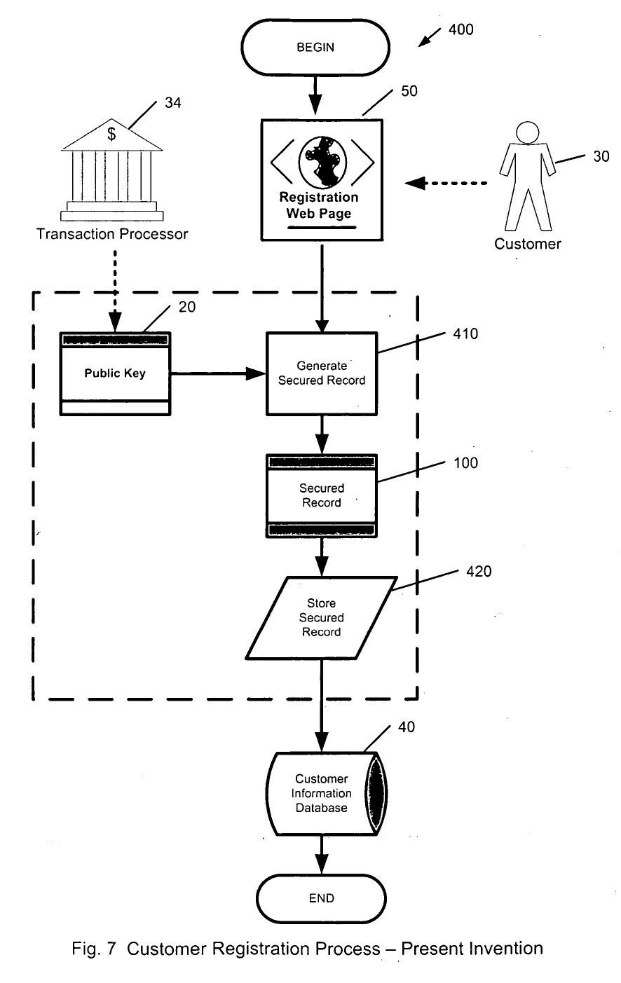

The overview of the invention outlined and shown as a tri-phase process in FIG. 1 is shown in greater detail in FIGS. 7-9. The dotted boxes in these three figures delineate the processes and records which are crucial to the present invention and highlight the differences from prior art processes summarized in FIG. 5 and FIG. 6.

FIG. 7 specifically shows the customer registration process 400 as disclosed by the present invention. The customer 30 completes a registration web page 50 provided by a merchant 32. The sensitive information acquired in this registration web page, is processed using the public key 20 provided by a transaction processor 34 for said merchant 32. A generate secured record process 410 secures the sensitive information and includes essential public information in the output form of a secured record 100. FIG. 11 and its associated explanation disclose in more detail this generation process. Following a store secured record process 420 which enters the secured record 100 into the customer information database 40 belonging to the merchant 32, the customer's sensitive credit card information is deleted. The stored sensitive information is now as secure as the cryptography process used to encrypt the private section 130 of the secured record 100. Nothing short of a thief stealing the private key, or a computer hacker breaking the encryption, could allow a malicious party access to the sensitive information in the secured customer information database 40.

Referring to FIG. 7, it is also possible, and in some cases preferable, for the transaction processor 34 to provide for the registration process 400 and creation of the secured record 100, which is then transmitted to the online merchant 32 for storage into the merchant's customer information database 40 for future use. Having the transaction processor 34 provide the registration process 400 allows for several advantages: 1) it relieves the merchant from having to generate the secured record; 2) it allows the customer to conveniently issue secured records to multiple merchants via a single registration procedure; 3) it allows the customer and the transaction processor to include constraints and other fields in the private section that are never visible to the merchant.

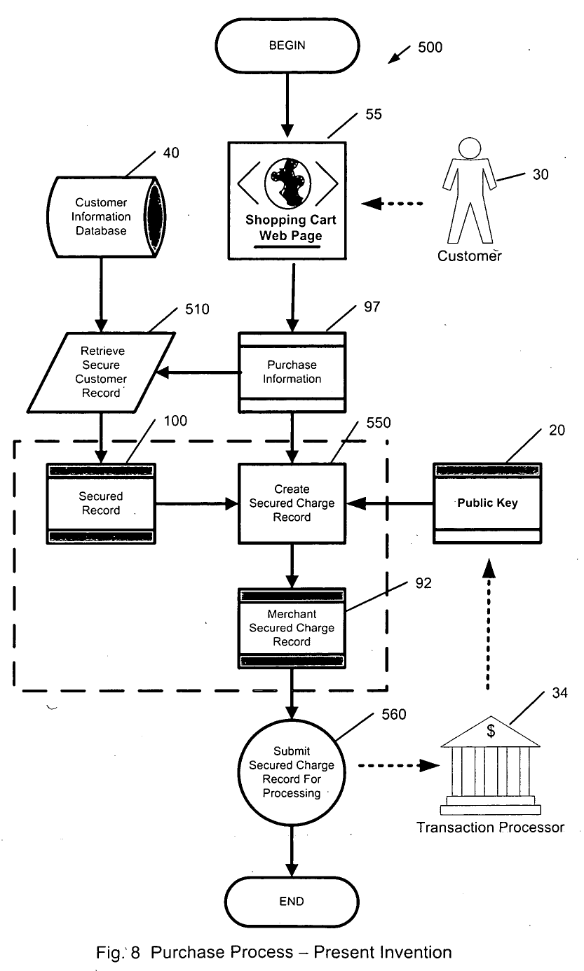

FIG. 8 specifically shows the customer purchase process 500 as defined by the present invention. The customer 30 places a purchase request by completing a shopping cart web page 55 provided by an online merchant 32. The purchase information 97 serves as input to the retrieve secure customer record process 510 which selects the appropriate secured record 100 pertaining to the customer 30 from the secured customer information database 40.

In the preferred embodiment, the process create secured charge record 550 combines the secured record 100, which was successfully retrieved from the customer information database 40, the purchase information 97, and the public key 20 to generate a merchant secured charge record 92. It is possible that the public key 20 used in this case to create the secured charge record 92 is identical to the one used to create the secured record 100, but this is not necessary. Any process to submit a secured charge record for processing 560 by the transaction processor 34 is more safe than the analogous submission process in prior art because of the encryption of the credit card information in secured charge record 92.

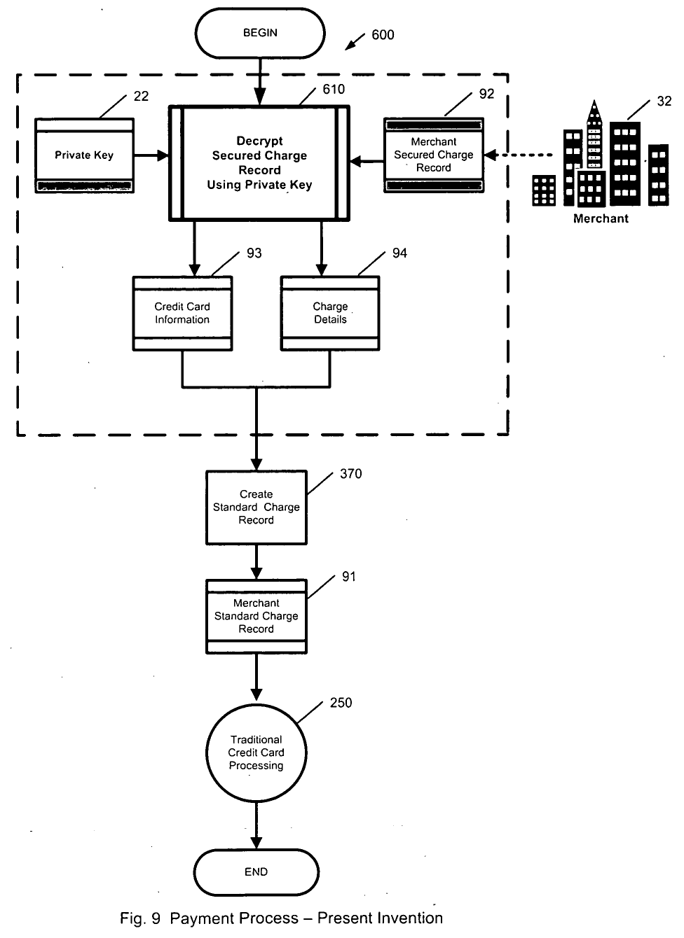

FIG. 9 specifically shows the overall credit card payment process 600 as disclosed by the present invention. A merchant 32 submits a merchant secured charge record 92 to a transaction processor 34 for payment. As shown, the transaction processor retrieves the private key 22 corresponding to the public key 20 used to encrypt the secured charge record 92. The decrypt secured charge record using private key process 610 is then run employing inputs private key 22 and merchant secured charge record 92. The outputs of this decryption process are the two records for credit card information 93 and charge details 94. Once these two records are output, they provide all the information necessary and sufficient to execute the process to create standard charge record 370. This process comprises the tasks of rearranging, reformatting, and reassembling the customer account information and shopping cart purchase information into the specific format used by the transaction processor 34 prior to use of the invention. The output record is then the standard charge record 91 which can then serve as input for traditional credit card processing 250.

### Alternative Methods for Secured Charge Record Decryption

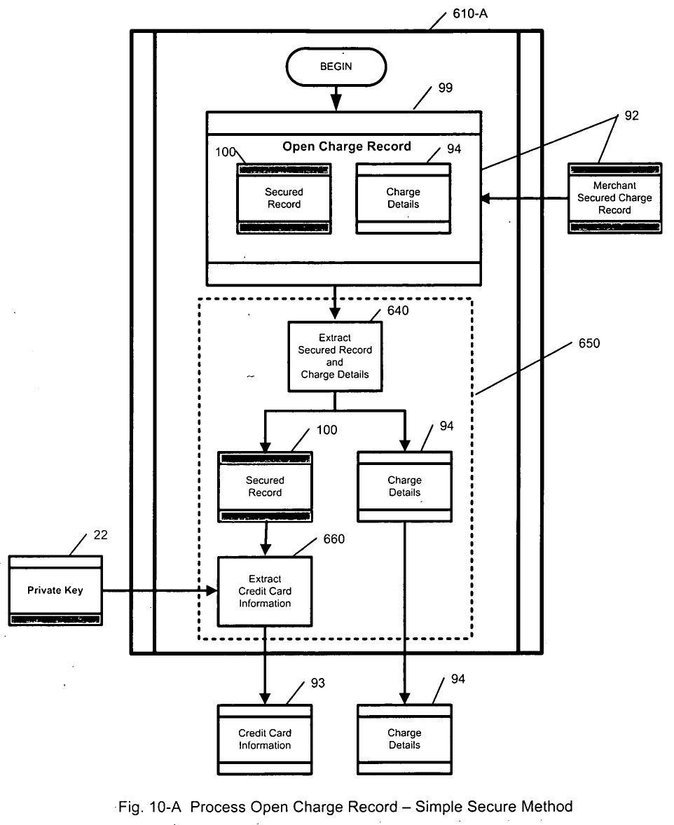

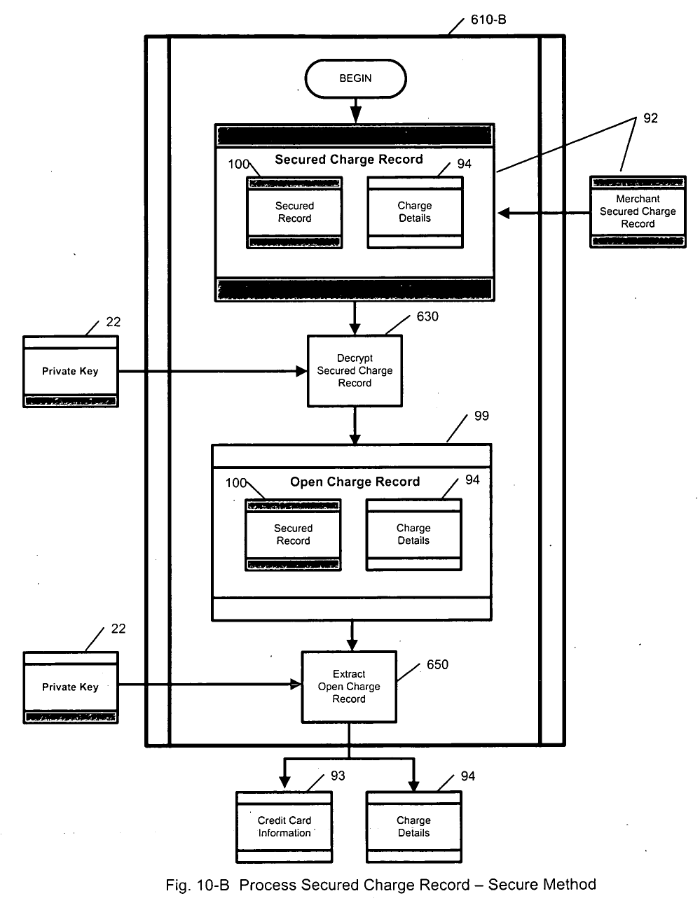

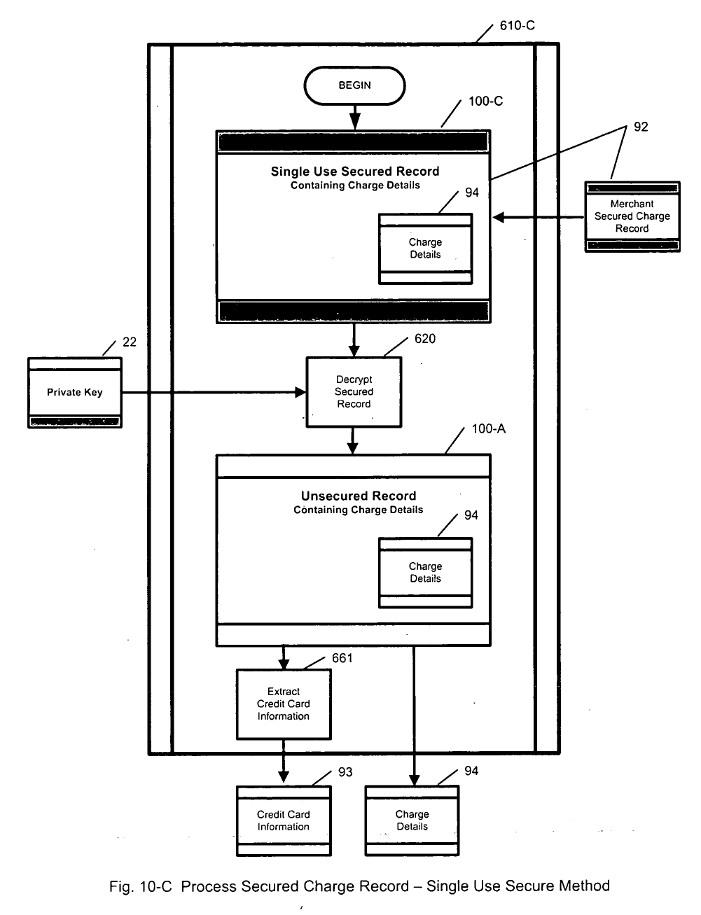

FIGS. 10-A, 10-B, and 10-C detail three of the possible embodiments of a process to decrypt secured charge record 610. All three take as input the private key 22 and the merchant secured charge record 92. And as also illustrated in these figures, the three associated processes output the two records for credit card information 93 and charge details 94. However in the three cases the secured charge request takes differing forms. The various secured charge request formats thereby possess their own relative advantages and disadvantages.

Shown in FIG. 10-A is the simple secure method to process the secured charge record 610-A. In this method, the secured charge record 92 wholly contains both the secured record 100, as disclosed in this invention, and the specific charge details 94. The actual creation of the secured charge record was shown in FIG. 8 and described above. In this variation, the two embedded records are only loosely associated within the secured charge record 92. In this case as seen in FIG. 10-A the secured charge record 92 is also termed an open charge record 99 because the charge details may be modified unknowingly. The simple secure method for decrypting the open charge record 99 affords the advantage of allowing the reuse of the secured record 100 which protects the critical credit card charge information. However the overall security this method provides is relatively weak as the charge details 94 can potentially be modified by a third party without the merchant or transaction processor being aware of the modifications.

The extract open charge record process 650 consists of a number of subtasks enclosed in the dashed box in FIG. 10-A. Because of the open structure of this charge record, a simple process to extract the secured record and charge details 640 directly results in the output of both the secured record 100 and charge details 94.

The transaction processor then uses the appropriate private key 22 to perform the extract credit card information process 660. Shown in FIG. 13 are the details of how the extract credit card information process 660 uses the private key 22 for decryption and then performs a validation before the final output of the credit card information 93.

Unlike the processes just described for isolation of the credit card information, the charge details 94 are already obtained following the process 640 and at completion of the process to extract credit card information 660, the simple secure method 610-A is complete.

Shown in FIG. 10-B is the secure method 610-B. Like the simple secure method 610-A described above, in secure method 610-B the secured charge record 92 also wholly contains both the secured record 100, and the specific charge details 94. However, in this variation, secured charge record contents are encrypted within the secured charge record 92. Because of this fact, the secure method 610-B affords the dual advantages of allowing the reuse of the secured record 100 and also protecting the charge details 94 from unauthorized viewing or modification. Because of the encryption used in this version of the secured charge record 92, the private key 22 must be used to decrypt the secured charge record 630 which results in the open charge record 99. Subsequent processing is essentially identical to that used in the simple secure method 650. This open charge record 99 and the private key serves as inputs to the extract open charge record process 650 which results in the output of both the credit card information 93 and charge details 94.

Shown in FIG. 10-C is the single use secure method 610-C. This method for handling the secured charge is typically employed when these charge records are of the type created when each purchase transaction triggers generation of a new secured record 100, most commonly when customer information is not stored by the merchant. The significance of this method is that it leverages the secured record itself by placing the charge details inside the secured record before the checksum is computed and the private section is encrypted. As such, this method provides for securing the charge details from tampering and possibly from viewing (if it is placed into the private section). However the secured record may only be used once, as the charge details will vary with each use, requiring its regeneration with each use.

As seen from the figures for the three various methods, the single use secure method 610-C differs from the simple secure method 610-A in that the charge detail information is protected by encryption in the former case. The single use secure method 610-C differs from the secure method 610-B in that the purchase information is placed inside the encrypted secured record 100-C. In the single use secure method 610-C the charge detail information are encrypted with the private section 130 of the secured record 100, where they were placed, thus making the secured record 100 only usable for a single purchase. Because of these facts, the single use secure method for decrypting the secured charge record 610-C does afford the advantage of security for the charge details 94 information. However the reusability of the secured record 100 as seen in the other two methods is lost, as it must be regenerated on a per purchase basis. In this method the processor uses the private key 22 as input to the process to decrypt secured record 620. This step results in the secured record unencrypted 100-A from which the credit card information 93 and the charge details 94 can be read.

It is to be noted that variations in the single use secured record are expected. For example, the charge details are preferably embedded in the private section to maximize security but may alternatively be embedded in the public section.

### Proxy Number Processing

The present invention also leverages the fact that many of the merchants who will adopt the use of this invention will be Internet-based businesses, and because of this, the protocols used to transmit the charge transaction from the merchant to the transaction processor are far more likely to be flexible, and thus provide for transmission of the new secured charge request in the transaction communication. However, in the event that this is not a practical reality, then the use of proxy numbers can be used to allow the secured records to reside in the transaction processor's database, and to allow the merchant to deal with proxy numbers which are indistinguishable from normal credit card numbers and require the merchant to do nothing different from their existing procedures using their existing applications and databases without modification.

In the case of proxy number usage, only the transaction processor has to accommodate any changes; the merchant and the customer continue to operate as they always have, other than the processor or merchant must issue the proxy number to the customer.

In the event that a proxy number is received in a traditional transaction, the processor must: 1) recognize the case of a proxy number in use; 2) use the proxy number to retrieve the secured record from the processor's database; 3) process the charge transaction using the secured record as described above.

Shown in FIG. 14 is the general structure of electronic commerce using the invention's proxy number 700. FIG. 14 shows an online transaction using the proxy number. The significance of the diagram is that the transaction is indistinguishable from an ordinary credit or debit card transaction, whether online, over the phone, or via point of sale locations. A customer 30 who has a proxy number completes a shopping cart web page 55 just as they would if they had a normal charge card number. The merchant creates a charge request in the existing format using said the proxy number for the credit card number. The charge request is then transmitted to the transaction processor in the traditional fashion. The secured record 100 retrieved using the proxy number, along with the corresponding private key 22 are used by the transaction processor in a process to decrypt and validate the secured record 620 resulting in the unsecured record 90. After an extraction process to retrieve the credit card number along with other necessary charge card information, the charge request follows traditional transaction processor credit card processing 250.

In the case of the use of the proxy number, the merchant needs to do nothing, as the proxy number will be indistinguishable from a normal credit card number, and will be submitted for processing in the same manner as all current charge requests.

### Key Revocation Process

In the event that the private key of the transaction processor has been compromised, all existing secured records that were created using the private key's corresponding public key must be abandoned. In order to facilitate this process, the transaction processor would provide either an online, or a batch key revocation process, whereby existing records would be submitted to the transaction processor, decrypted using the old compromised private key, and re-encrypted using the new public key corresponding to the new uncompromised private key. The reason that the records must be submitted to the transaction processor for re-encryption, is that the transaction processor is the only party, other than the party which compromised the original key-pair, capable of decrypting the contents of the private section of the record for the purpose of re-encryption.

Alternatively, the merchant could expire all of the existing secured records and require their customers to re-establish the records by re-entering their credit card information, and then generating new secured records, using the new public key corresponding to the new uncompromised private key.

In either case, the processor must make the merchants aware of the compromise, and declare an expiration date after which secured records created with the compromised key will be rejected. The processor must also redistribute the new public key to all merchants. It is expected that special web-services will be developed to fully automate this procedure.

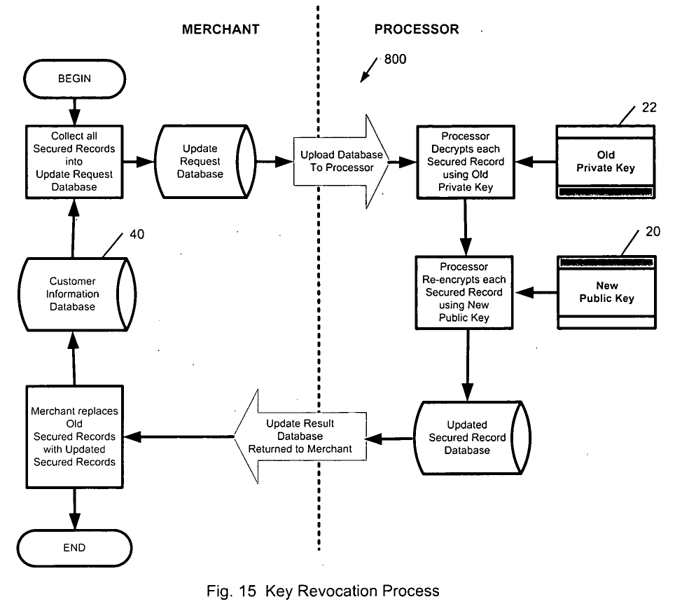

FIG. 15 shows the general structure of the key revocation process 800. The merchant 32 collects all secured records and forms an update request database. The database is uploaded to the transaction processor 34. Said transaction processor 34 decrypts each secured record using the old private key 22 originally used to encrypt the records but now compromised. The processor 34 then uses a new and hence uncompromised public key 20 to re-encrypt each secured record. These newly secured records are combined in an updated secured record database which is transmitted back to the merchant 32 who then replaces the old secured records with the updated secured records thereby resecuring the customer information database 40.

The description of the invention is merely exemplary in nature and, thus, variations that do not depart from the general design of the invention are intended to be within the scope of the invention. Such variations are not to be regarded as a departure from the intent and scope of the invention.

What is claimed is:

1. A method for protecting sensitive information stored in electronic commerce databases and transmittance of transactions based upon said database information comprising:
(a) providing a record structure able to secure sensitive information in a private section which is protected from unauthorized viewing, while also providing information in a public section which may be viewed by anyone with access to the record;
(b) providing a means of constraining the usage of information in said public and private sections with constraint definitions embedded in said public and private sections;
(c) providing a means to ensure the integrity of said record structure by placing the equivalent of a checksum of the contents of said record into said private section;
(d) providing a means for securing sensitive information and checksum in said record structure by encrypting the contents of the private section of said record structure;
whereby the sensitive information used to authorize credit transactions, which is stored and transmitted by merchants and other parties for the purpose of facilitating purchases, is secured from viewing by anyone except authorized parties by the use of encryption, while the integrity of the record is verifiable using the record checksum, and the usage of the record is constrained to specific intents defined to protect the involved parties from theft and fraud.

2. A method for securing sensitive information relating to credit and debit cards, which is stored by merchants and other parties for the purpose of facilitating purchases, by defining a special secured record which makes the sensitive information viewable only by the party needing the sensitive or private information, and makes said secured record practicably usable only by the customer or owner of the credit or debit card; said method comprising of the following steps:
(a) collecting said sensitive information, as well as other customer information, from a customer using existing procedures;
(b) collecting public information from said customer and combining it along with usage constraints including at least a unique merchant identification, to create a public section of the secured record;
(c) combining all private constraints, such as a list of merchant approved debit accounts, with said sensitive information, to create a private section of the secured record;
(d) computing a checksum of the entire secured record, or at a minimum the public section, and storing it into said private section of the secured record;
(e) encrypting the private section using the public key of a key pair provided by a payment processor that will ultimately process the payment transaction;
(f) the merchant storing the secured record;
(g) the merchant transmitting the secured record combined with details of a purchase when submitting a transaction to said payment processor;
(h) the payment processor receiving the secured record in the secured charge request from the merchant for said transaction, using the private key to decrypt the private section, said private key corresponding to the public key used to encrypt the private section of the secured record, extracting the checksum value from the private section of the record, validating the secured record using the extracted checksum, and if the secured record is valid, and if the secured record usage meets all applicable usage constraints, then extracting all required sensitive credit card information, and finally processing the transaction for said purchase details using the extracted credit card information and traditional procedures and systems.

3. The method of claim 2 wherein the processing steps of a-e for creation of said secured record are performed by software that is running on the customers computer, and is then transmitted to the merchant for storage, as in step f.

4. The method of claim 2 wherein the processing steps of a-e for creation of said secured record are performed by a merchant or some other third party thereby necessitating an additional step before or after storage of the secured record wherein said merchant or third party deletes all instances of the collected sensitive information used to create the private section of the secured record.

5. The method of claim 2 wherein the merchant is storing said secured record using a lookup key that uses the same format as a credit card number and saving said key into the location where said credit card number was previously stored, allowing the secured record to easily substitute for the credit card number in the existing database with a minimum of change.

6. The method of claim 5 wherein the last four digits of the secured record lookup key being stored in place of the credit card number whose last four digits are often displayed by the merchant as a convenient means of identifying the credit card being used for payment, are set to be equal to the last four digits of the credit card number contained in the secured record referenced by said lookup key, while the remaining lookup key digits are used to store the actual key used to retrieve the secured record thereby permitting existing systems to continue to display the last four digits of the credit card number without any modifications.

7. The method of claim 2 wherein before step d or computation of the checksum a header section is included in the secured record in addition to the public and private sections, said header section serving to provide information about the record such as versioning and content descriptions, among other general fields which might describe meta-information about the secured record thereby providing for more flexible processing options, as well as backward compatibility capabilities.

8. The method of claim 1 wherein a transaction is secured for transmission by defining a transaction record, which includes the secured record to ensure the security of any sensitive information being provided as part of said transaction.

9. The method of claim 8 wherein said transaction record is a simple open record which includes the transaction details and the secured record, whereby the transaction details are subject to viewing and modification while the secured record continues to protect the sensitive information and can be reused over many transactions.

10. The method of claim 8 wherein said transaction record uses a structure similar to the secured record, whereby the transaction details can be made secure by placing them into a private section, and the integrity of the transaction details are ensured via a checksum mechanism, and the secured record is included in the transaction record thereby continuing to protect the sensitive information and allowing reuse over many transactions.

11. The method of claim 8 wherein said secured charge record serves the dual purpose of being the secured record itself, while also serving as the secured charge record by providing for the transaction details by placing said transaction details into the public or private sections of the secured record, thus preventing the secured record from being reused for other transactions.

12. A method of payment transaction processing that allows for the use of a reusable proxy number, said proxy number used as a unique identifier for the secured record in claim 1, and said proxy number being interchangeable and accepted by merchants as a traditional payment method number such as a credit card number, and said proxy number being identifiable by the clearing entity as representing a secured record to be used for payment information, said secured record being stored by the clearing entity.

13. A method for handling key revocation for multiple revoked secured records belonging to a particular class of customers, said class being based on the same expired, compromised, or otherwise revoked key pair used in the generation of said secured records; such method involving the transmission of the secured records to be regenerated to the owner of the private key corresponding to the public key used to encrypt said secured records, said key pair owner using said revoked private key to decrypt said secured records, then said owner regenerating said secured records using the new valid private key, then said owner transmitting the regenerated secured records back to the originator of the transaction, who then replaces the old revoked secured records with the new valid secured records, said method requiring no involvement of the customers whose sensitive information is stored in said secured records.
